(19) United States
(12) Patent Application Publication
(10) Pub. No.: US 2023/0060578 A1
(43) Pub. Date: Mar. 2, 2023

(54) ROAD CONDITION MONITORING SYSTEM

(71) Applicant: The Goodyear Tire & Rubber Company, Akron, OH (US)

(72) Inventors: Kanwar Bharat Singh, Bofferdange (LU); Arash Nouri, Blacksburg, VA (US); Sven Schaefer-O'Reilly, Bissen (LU)

(21) Appl. No.: 17/820,653

(22) Filed: Aug. 18, 2022

Related U.S. Application Data
(60) Provisional application No. 63/238,274, filed on Aug. 30, 2021.

(51) Int. Cl. B60W 40/06

(52) U.S. Cl. CPC B60W 40/06; B60W 2520/26; B60W 2520/28; B60W 2555/20

(57) ABSTRACT

A road condition monitoring system for a vehicle is provided. The vehicle is supported by at least one tire and includes a central communication system. The system includes a processor in electronic communication with the central communication system. An identifier is in electronic communication with the processor, receives vehicle condition data from the central communication system, and identifies a free rolling instance of the at least one tire. A slip estimator is in electronic communication with the processor, receives speed data from the central communication system, and determines slip characteristics of the at least one tire during the free rolling instance. A classifier is in electronic communication with the processor, receives the slip characteristics of the at least one tire, and identifies a road surface condition from the slip characteristics.

### FIELD OF THE INVENTION

The invention relates generally to vehicle and tire monitoring systems. More particularly, the invention relates to systems that measure and collect vehicle and tire data. The invention is directed to a system that employs vehicle and tire data to determine the local slip of a tire and estimate a road condition in real time.

### BACKGROUND OF THE INVENTION

The condition of the road on which a vehicle is traveling affects performance of the vehicle and the tires that support the vehicle. As a result, it is beneficial to determine the condition of the road as the vehicle travels. If the road condition can be determined, the condition may be employed in a vehicle control system to improve handling and performance of the vehicle. However, accurate and reliable detection of road conditions for use by such systems has been difficult to achieve.

In the prior art, there has been a common belief that a tire under a free rolling or cruising condition experiences little to no slip. Slip is the relative motion between the tire and the road surface. A free rolling or cruising condition is experienced when the vehicle supported by the tire is driven at a constant speed on a straight road, so that the tire experiences low or no forces from acceleration, deceleration, or cornering.

However, it has been determined that a tire does experience quantifiable local slip during free rolling or cruising conditions. It has also been determined that quantification of local slip of the tire during free rolling or cruising conditions may enable the condition of the road surface to be estimated, which may then be employed in vehicle control systems. By way of example, a vehicle control system may include brake control systems, suspension control systems, steering control systems, and the like. Such vehicle control systems may be employed on any vehicle, including driver-operated vehicles, driver-assisted vehicles, and autonomous vehicles.

Quantification of local slip of the tire during free rolling or cruising conditions may be accomplished by measuring slip with a high frequency accelerometer mounted in the tire. However, a high frequency accelerometer is a specialized sensor that is costly to install in a tire. Therefore, direct measurement of local slip of the tire during free rolling or cruising conditions is not an economically viable manner of quantifying slip.

As a result, there is a need in the art for a system that accurately and reliably estimates the slip of a tire during free rolling or cruising conditions in an economical manner, which in turn enables estimation of a road condition in real time.

### SUMMARY OF THE INVENTION

According to an aspect of an exemplary embodiment of the invention, a road condition monitoring system for a vehicle is provided. The vehicle is supported by at least one tire and includes a central communication system. The system includes a processor in electronic communication with the central communication system. An identifier that is in electronic communication with the processor receives vehicle condition data from the central communication system and identifies a free rolling instance of the at least one tire. A slip estimator that is in electronic communication with the processor receives speed data from the central communication system and determines slip characteristics of the at least one tire during the free rolling instance. A classifier that is in electronic communication with the processor receives the slip characteristics of the at least one tire and identifies a road surface condition from the slip characteristics.

### BRIEF DESCRIPTION OF THE DRAWINGS

The invention will be described by way of example and with reference to the accompanying drawings, in which:

FIG. 1 is a perspective view of an exemplary vehicle and tire employing the road condition monitoring system of the present invention;

FIG. 2 is a plan view of the vehicle shown in FIG. 1, with certain portions of the vehicle represented by dashed lines;

FIG. 3 is a schematic diagram of the vehicle shown in FIG. 1 with a representation of data transmission to a cloud-based server and to a user device;

FIG. 4 is a graphical representation of a tire force curve showing a free rolling zone;

FIG. 5 is a first schematic diagram of an exemplary embodiment of a system for estimating a road condition of the present invention;

FIG. 6 is a second schematic diagram of the exemplary embodiment of the system for estimating a road condition of the present invention showing estimation of a reference value for tire slip;

FIG. 7 is a graphical representation of temperature versus relative humidity from FIG. 6; and

FIG. 8 is a third schematic diagram of the exemplary embodiment of the system for estimating a road condition of the present invention.

Similar numerals refer to similar parts throughout the drawings.

### DEFINITIONS

“Axial” and “axially” means lines or directions that are parallel to the axis of rotation of the tire.

“CAN bus” or “CAN bus system” is an abbreviation for controller area network system, which is a vehicle bus standard designed to allow microcontrollers and devices to communicate with each other within a vehicle without a host computer. CAN bus is a message-based protocol, designed specifically for vehicle applications.

“Circumferential” means lines or directions extending along the perimeter of the surface of the annular tread perpendicular to the axial direction.

“Equatorial centerplane (CP)” means the plane perpendicular to the tire’s axis of rotation and passing through the center of the tread.

“Footprint” means the contact patch or area of contact created by the tire tread with a flat surface as the tire rotates or rolls.

“Inboard side” means the side of the tire nearest the vehicle when the tire is mounted on a wheel and the wheel is mounted on the vehicle.

“Lateral” means an axial direction.

“Lateral edges” means a line tangent to the axially outermost tread contact patch or footprint of the tire as measured under normal load and tire inflation, the lines being parallel to the equatorial centerplane.

“Net contact area” means the total area of ground contacting tread elements between the lateral edges around the entire circumference of the tread of the tire divided by the gross area of the entire tread between the lateral edges.

“Outboard side” means the side of the tire farthest away from the vehicle when the tire is mounted on a wheel and the wheel is mounted on the vehicle.

“Radial” and “radially” means directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“Slip” is the relative motion between the tire and the road surface.

“Slip angle” is the angle between a vehicle’s direction of travel and the direction in which the front wheels are pointing. Slip angle is a measurement of the deviation between the plane of tire rotation and the direction of travel of a tire.

“Tread element” or “traction element” means a rib or a block element defined by a shape having adjacent grooves.

“Tread Arc Width” means the arc length of the tread of the tire as measured between the lateral edges of the tread.

### DETAILED DESCRIPTION OF THE INVENTION

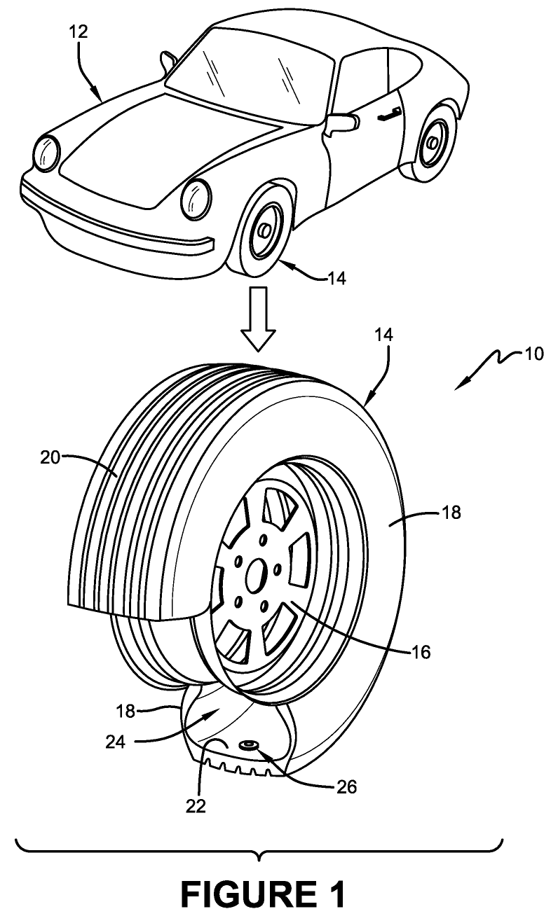

An exemplary embodiment of the road condition monitoring system of the present invention is indicated at 10 in FIGS. 1 through 8. Turning to FIG. 1, a vehicle 12 is supported by tires 14. While the vehicle 12 is depicted as a passenger car, the invention is not to be so restricted. The principles of the invention find application in other vehicle categories such as commercial trucks in which vehicles may be supported by more or fewer tires than shown in FIG. 1.

The tires 12 are of conventional construction, and each tire is mounted on a respective wheel 16 as known to those skilled in the art. Each tire 14 includes a pair of sidewalls 18 that extend to a circumferential tread 20. An innerliner 22 is disposed on the inner surface of the tire 14, and when the tire is mounted on the wheel 16, an internal cavity 24 is formed, which is filled with a pressurized fluid, such as air.

A sensor unit 26 preferably is mounted to each tire 14, preferably by attachment to the innerliner 22 by means such as an adhesive. The sensor unit 26 measures certain characteristics of the tire 14, including tire pressure and temperature. For this reason, the sensor unit 26 preferably includes a pressure sensor and a temperature sensor, and may be of any known configuration, such as a tire pressure management system (TPMS) sensor, and will be referred to as a TPMS sensor unit or a TPMS sensor. The TPMS sensor unit 26 preferably also includes electronic memory capacity for storing identification (ID) information for each tire 14, known as tire ID information. It is to be understood that the TPMS sensor unit 26 may be a single unit, or may include more than one unit, and the sensor unit may be mounted on a structure of the tire 14 other than the innerliner 22.

The tire ID information may include or be correlated to specific data for each tire 14, including: a position of the tire on the vehicle 12; tire size, such as rim size, width, and outer diameter; tire type, such as all weather, summer, winter, off-the-road, and the like; tire segment, which is the specific product line to which the tire belongs; predetermined traction or weather parameters, such as a three-peak snowflake indicator for winter tires (3PSF); Department of Transportation (DOT) code; wet grip index, which is a predetermined value based on a standardized test; tire model; manufacturing location; manufacturing date; treadcap code, which includes or correlates to a compound identification; a mold code that includes or correlates to a tread structure identification; a tire footprint shape factor (FSF); a mold design drop; a tire belt/breaker angle; and/or an overlay material. The tire ID information 32 may also correlate to a service history or other information to identify specific features and parameters of each tire 14, as well as mechanical characteristics of the tire, such as cornering parameters, spring rate, load-inflation relationship, and the like.

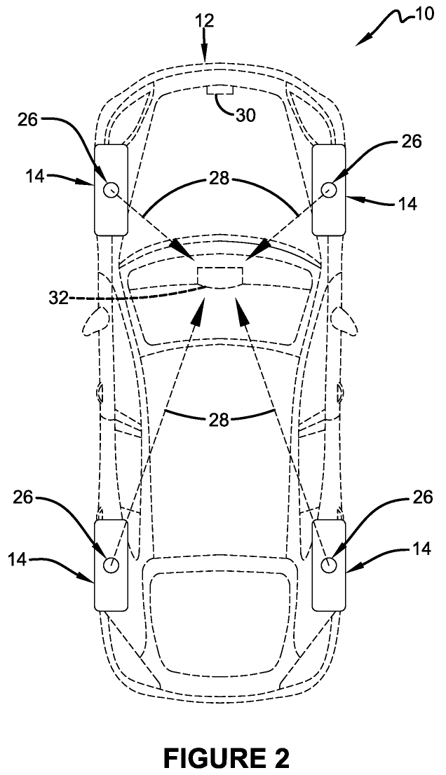

Referring to FIG. 2, the vehicle 12 includes a central communication system 28 that enables electronic communication with the TPMS sensor units 26 and sensors 30 that are mounted on the vehicle, and may be a wired or a wireless system. By way of example, reference shall be made to a CAN bus system 28, with the understanding that such reference includes any central electronic communication system for a vehicle, whether it is physically incorporated into the vehicle 12 or is cloud-based. Aspects of the road condition monitoring system 10 preferably are executed on a processor 32 that is accessible through the vehicle CAN bus 28. The CAN bus 28 enables the processor 32, and accompanying memory, to receive input of data from the sensors 26 and 30 and to interface with other electronic components, as will be described in greater detail below.

As mentioned above, it is beneficial to determine the condition of the road over which the vehicle 12 travels. If the road condition can be determined, the condition may be employed in a vehicle control system through the vehicle CAN bus 28 to improve handling and performance of the vehicle 12. It has been determined that quantification of slip of the tire 14 during free rolling or cruising conditions may enable the condition of the road surface to be estimated. However, quantification by direct measurement of slip of the tire 14 during free rolling or cruising conditions is not economically viable.

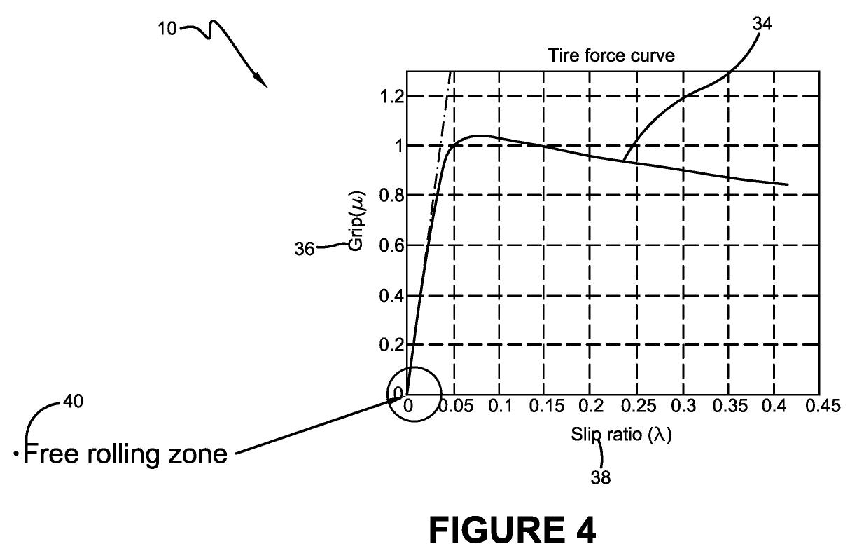

The road condition monitoring system 10 determines a road condition using an indirect technique, which employs standard vehicle sensors 26 and 30 to capture local slip behavior of the tire 14 during free rolling or cruising conditions. For the purpose of convenience, reference hereinafter shall be made to free rolling conditions, free rolling state, and free rolling instance, with the understanding that such reference includes cruising conditions, cruising state, and cruising instance, respectively. FIG. 4 shows a tire force curve 34, which plots tire grip 36 versus tire slip ratio 38, and shows a free rolling zone 40. The free rolling zone 40 exists when the tire 14 is in free rolling conditions or a free rolling state.

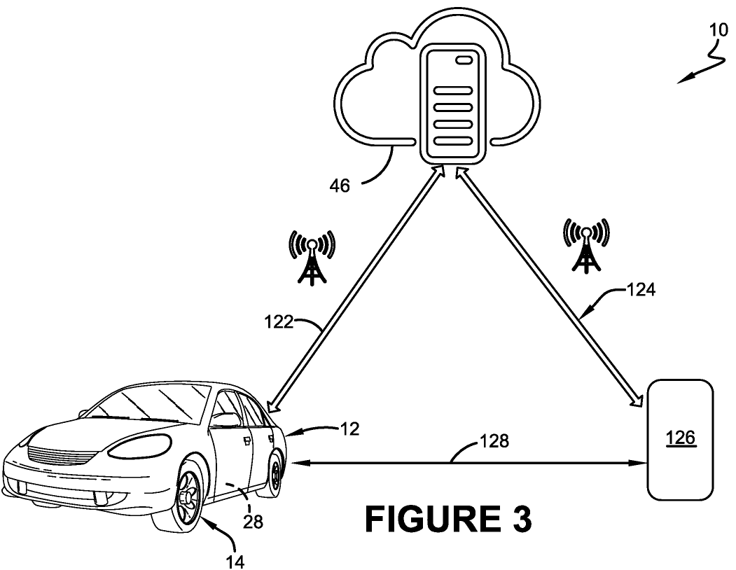

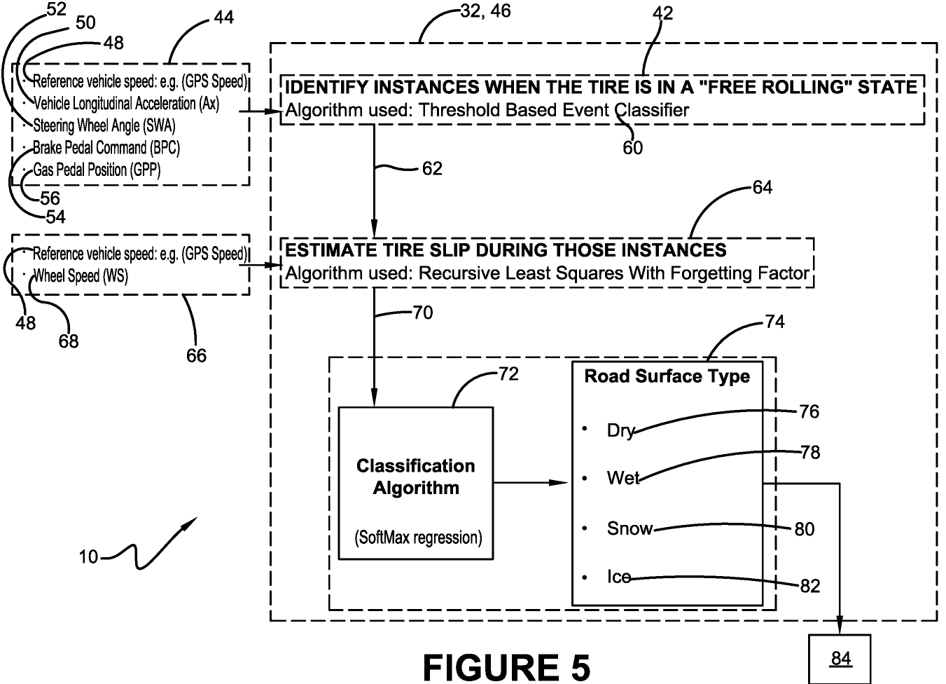

With reference to FIG. 5, the road condition monitoring system 10 includes an identifier 42 that identifies when the tire 14 is in a free rolling state. The identifier 42 receives vehicle condition data 44 from the CAN bus system 28 (FIG. 2). The identifier 42 may be stored on the local vehicle-mounted processor 32 or on a remote Internet or cloud-based processor 46 (FIG. 3), as will be described below. The vehicle condition data 44 preferably includes a vehicle reference speed 48 that may be from a global positioning system (GPS), a vehicle longitudinal acceleration 50, a steering wheel angle 52, a brake pedal command 54, and/or a gas pedal position 56. The vehicle condition data 44 is electronically communicated from the CAN bus system 28 to the processor 32 or 46, and is input into the identifier 42.

The identifier 42 preferably includes a threshold based event classifier 60, which analyzes the vehicle condition data 44. For example, the event classifier 60 may be a linear classifier, nonlinear classifier, or a Bayesian statistical classifier. The vehicle condition data 44 are input into respective categories, and predetermined thresholds have been set for each vehicle condition. When the predetermined thresholds are met, the tire 14 is classified as being in a free rolling state. For example, when the vehicle reference speed 48 is constant, the vehicle longitudinal acceleration 50 is minimal, the steering wheel angle 52 is constant, the brake pedal command 54 is minimal or zero, and the gas pedal position 56 is constant, the tire 14 is classified as being in a free rolling state, which in turn identifies a free rolling instance 62.

When a free rolling instance 62 is identified by the identifier 42, the road condition monitoring system 10 determines slip characteristics of the tire 14 during the free rolling instance. For example, a slip estimator 64 may be employed to estimate the slip of the tire 14 during the free rolling instance 62. The slip estimator 64 may be stored on the local vehicle-mounted processor 32 or on the remote Internet or cloud-based processor 46. The slip estimator 64 is in electronic communication with the CAN bus system 28 and receives speed data 66 from the CAN bus system. The speed data 66 preferably includes the vehicle reference speed 48 that may be from a global positioning system (GPS) in kilometers per hour (kph) or miles per hour (mph), and a wheel speed 68, which is the speed of the wheel 16 on which the tire 14 is mounted, in kph or mph. The slip estimator 64 estimates tire slip 70 as a percentage difference between the wheel speed 68 and the vehicle speed 48:

$$\begin{matrix}\text{Tire Slip (\%) =} \\ \frac{\text{Wheel Speed (kph) - Vehicle Reference Speed (kph)}}{\text{Wheel Speed (kph)}} \times 100 \%\end{matrix}$$

Preferably, the slip estimator 64 employs a recursive least squares algorithm with a forgetting factor, which is a recursive application of a least squares regression algorithm that enables each new data point to be taken into account. The forgetting factor provides less weight to older data points, thereby ensuring that the tire slip estimation 70 is based on the most recent data and thus is a real time estimation.

When the slip characteristic of the tire 14 is the tire slip estimation 70 as determined by the slip estimator 64, a classifier 72 that is in electronic communication with the slip estimator receives the tire slip estimation and identifies a road surface condition 74. The classifier 72 may be stored on the local vehicle-mounted processor 32 or on the remote Internet or cloud-based processor 46. In such a case, the classifier 72 identifies the road surface condition 74 based on the magnitude of the estimated tire slip 70. Preferably, the classifier 72 employs a multinomial logistic regression classification methodology, such as a softmax regression, to identify the road surface condition 74. The multinomial logistic regression classification methodology is preferred based on its capability to predict the probabilities of different outcomes of a categorically distributed dependent variable when given a set of independent variables.

The road surface condition 74 identified by the classifier 72 preferably is output by road surface type. For example, the road surface condition 74 may include a dry surface 76, a wet surface 78, a snow-covered surface 80, an icy surface 82, and/or variations and combinations thereof. The road surface condition 74 may then be output from the road condition monitoring system 10 and input through the CAN bus system 28 into vehicle control systems and/or into other discrete estimation systems 84. For example, the road surface condition 74 may be input into a tire grip estimation system that employs a technique shown and described in U.S. Pat. Application Publication No. 2021/0229670, which is owned by the same Assignee as the instant Application, The Goodyear Tire & Rubber Company, and which is incorporated herein in its entirety.

It has been discovered that the tire slip estimation 70 from the slip estimator 64 may not be as consistently accurate as desired due to variation in the radius of the tire 14. Such variation may stem from expansion of the tire 14 during operation of the vehicle 12, aging of the tire, and/or wear of the tire. When the tire slip estimation 70 is not as consistently accurate as desired, the identification of the road surface condition 74 by the classifier 72 may be less accurate than is desired.

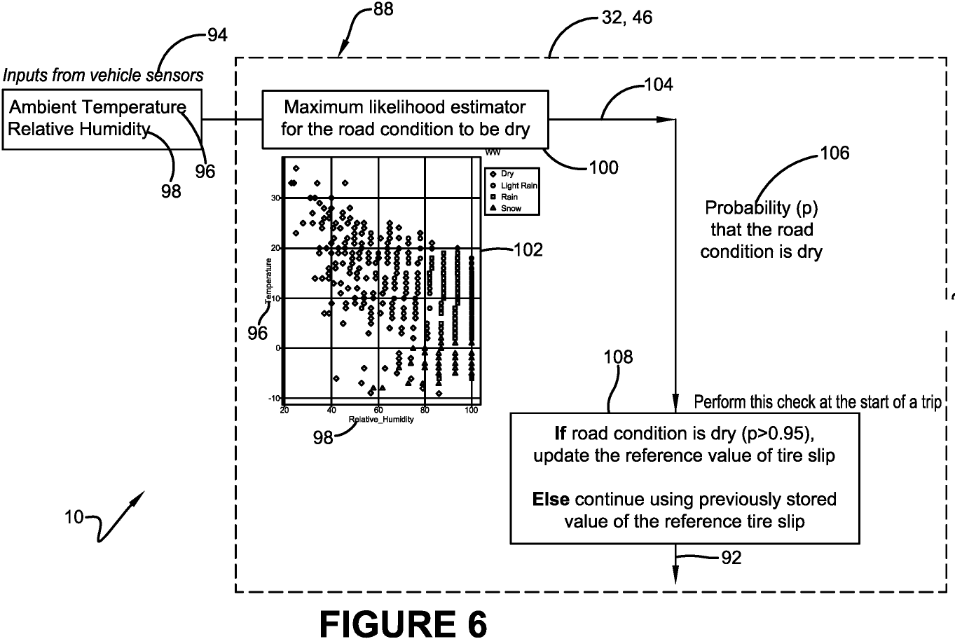

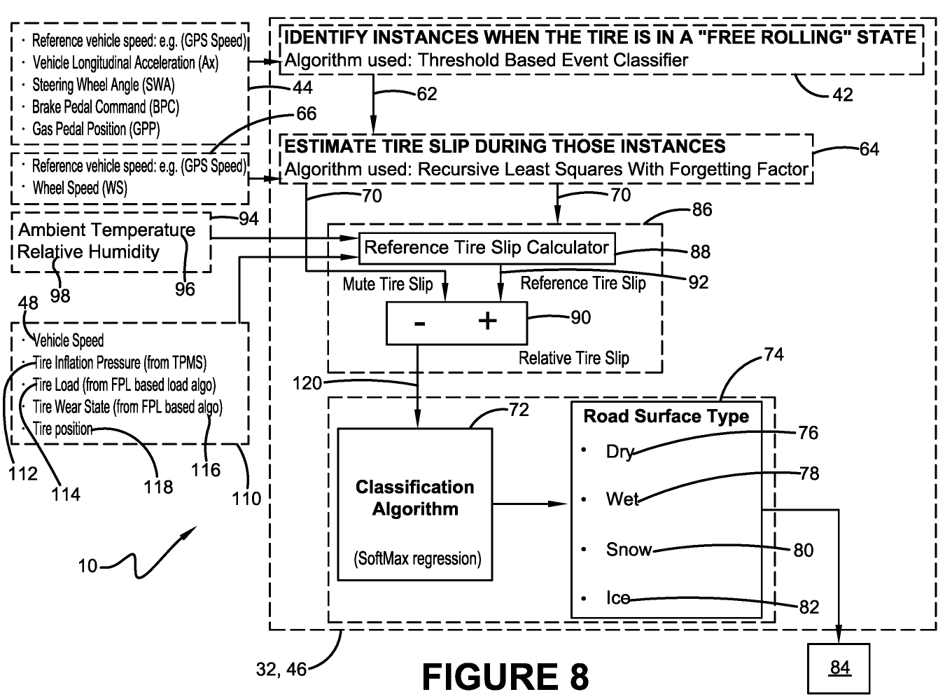

Turning to FIGS. 6 and 8, the road condition monitoring system 10 may determine other slip characteristics of the tire 14 to adjust the tire slip estimation 70 and account for variation in the radius of the tire 14. For example a correction to the tire slip estimation 70 may be made by estimating a relative change in slip. The estimation of relative change in slip of the tire 14 is performed by a slip adjustor 86. The slip adjustor 86 preferably includes a reference slip calculator 88 and a relative slip calculator 90.

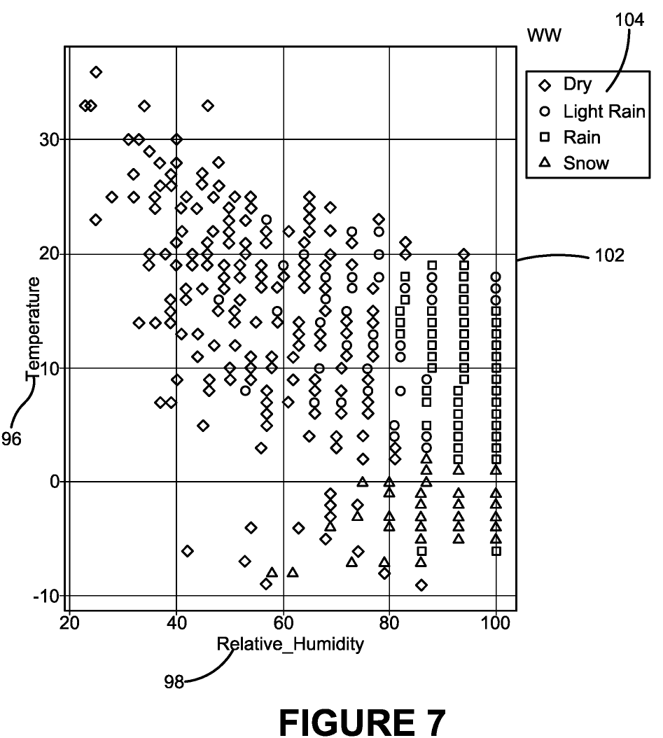

The reference slip calculator 88 estimates a reference slip value 92. The reference slip calculator 88 receives vehicle atmospheric condition data 94 from the CAN bus system 28, which preferably includes an ambient temperature 96 and a relative humidity 98. A dry road condition estimator 100 analyzes the atmospheric condition data 94 to determine if the road on which the vehicle 12 is traveling is dry. For example, with additional reference to FIG. 7, the received ambient temperature 94 and the received relative humidity 98 may be plotted 102 against one another. When the plot 102 indicates a dry road condition 104, the estimator 100 generates a probability 106 of road dryness. When the probability 106 is greater than a predetermined probability threshold 108, such as about 0.95, the most recent tire slip estimation 70 from the slip estimator 64 is used as the reference slip value 92. When the probability 106 is less than the predetermined probability threshold 108, a prior tire slip estimation 70 that was used as the reference slip value 92 is retained as the reference slip value.

Returning to FIG. 8, the road condition monitoring system 10 preferably also analyzes vehicle speed 48 and tire-related data 110 to account for short term variations in tire conditions that may affect tire slip, thereby increasing the robustness of the system. The tire-related data 110 preferably includes tire pressure 112 as measured by the TPMS sensor 26, a load 114 on the tire 14, a wear state 116 of the tire, and/or a position 118 of the tire on the vehicle 12. The tire load 114 may be measured by a load sensor, or may be calculated by a load estimation technique, such as the one shown and described in U.S. Pat. No. 10,245,906, which is owned by the same Assignee as the instant Application, The Goodyear Tire & Rubber Company, and which is incorporated herein in its entirety. The tire wear state 116 may be measured by a wear sensor, or may be calculated by a wear estimation technique, such as the one shown and described in U.S. Pat. Application Publication No. 2021/0061022, which is owned by the same Assignee as the instant Application, The Goodyear Tire & Rubber Company, and which is incorporated herein in its entirety. The tire position 118 may be input from a sensor or from the above-described tire ID information, or may be calculated by a location technique, such as the one shown and described in U.S. Pat. Application Serial No. 17/151,310, which is owned by the same Assignee as the instant Application, The Goodyear Tire & Rubber Company, and which is incorporated herein in its entirety.

The vehicle speed 48 and tire-related data 110 are input into the reference slip calculator 88 to improve the estimation of the reference slip value 92 by employing thresholds or ranges in a manner similar to that as described above. For example, when the vehicle speed 48 is inside of a predetermined optimum range, the most recent tire slip estimation 70 from the slip estimator 64 is used as the reference slip value 92. When the vehicle speed 48 is outside of the predetermined optimum range, a prior tire slip estimation 70 that was used as the reference slip value 92 is retained as the reference slip value. When the tire pressure 112 is above a predetermined minimum threshold, the most recent tire slip estimation 70 from the slip estimator 64 is used as the reference slip value 92. When the tire pressure 112 is below the predetermined minimum threshold, a prior tire slip estimation 70 that was used as the reference slip value 92 is retained as the reference slip value.

When the tire load 114 is below a predetermined minimum threshold, the most recent tire slip estimation 70 from the slip estimator 64 is used as the reference slip value 92. When the tire load 114 is above the predetermined minimum threshold, a prior tire slip estimation 70 that was used as the reference slip value 92 is retained as the reference slip value. When the tire wear state 116 is below a predetermined minimum threshold, the most recent tire slip estimation 70 from the slip estimator 64 is used as the reference slip value 92. When the tire wear state 116 is above the predetermined minimum threshold, a prior tire slip estimation 70 that was used as the reference slip value 92 is retained as the reference slip value. If the position 118 of the tire 14 is consistent with a previously indicated position, the most recent tire slip estimation 70 from the slip estimator 64 is used as the reference slip value 92. If the position 118 of the tire 14 is consistent with the previously indicated position, a prior tire slip estimation 70 that was used as the reference slip value 92 is retained as the reference slip value.

The reference slip calculator 88 thus determines and outputs an optimum reference slip value 92. The optimum reference slip value 92 is input into the relative slip calculator 90 along with the above-described the slip estimation 70 from the slip estimator 64. The relative slip calculator 90 compares the slip estimation 70 from the slip estimator 64 and the optimum reference slip value 92 to determine a relative change in tire slip 120.

When the slip characteristic of the tire 14 is the relative change in tire slip 120, the classifier 72 receives the relative change in tire slip to identify the road surface condition 74. In such a case, the classifier 72 identifies the road surface condition 74 based on the magnitude of the relative change in tire slip 120. As described above, the classifier 72 preferably employs a multinomial logistic regression classification methodology, such as a softmax regression, to identify the road surface condition 74. The road surface condition 74 identified by the classifier 72 preferably is output according to road surface type, such as a dry surface 76, wet surface 78, snow-covered surface 80, icy surface 82, and/or variations and combinations thereof.

As described above, the road surface condition 74 may be output from the road condition monitoring system 10 and input through the CAN bus system 28 into vehicle control systems and/or into other discrete estimation systems 84. For example, the road surface condition 74 may be input into the above-described tire grip estimation system. The vehicle control systems may include brake control systems, suspension control systems, steering control systems, and the like. Such vehicle control systems may be employed on any vehicle, including driver-operated vehicles, driver-assisted vehicles, and autonomous vehicles.

With reference to FIG. 3, the road condition monitoring system 10 may be stored on a local, vehicle-mounted processor 32 or on a remote Internet or cloud-based processor 46, with wireless data transmission 122 between the vehicle 12 and the cloud-based processor. The road surface condition 74 may also be wirelessly transmitted 124 from the cloud-based processor 46 to a display device 126 for a display that is accessible to a user of the vehicle 12, such as a smartphone, or to a fleet manager. Alternatively, the road surface condition 74 may be wirelessly transmitted 128 from the vehicle CAN bus 28 to the display device 126.

In this manner, the road condition monitoring system 10 identifies free rolling conditions of a tire 14 and accurately and reliably estimates the slip of the tire during the free rolling conditions in an economical manner, which in turn enables estimation of a road surface condition 74 in real time. The road condition monitoring system 10 determines the road surface condition 74 with an indirect technique, which employs standard vehicle sensors to capture local slip behavior of each tire 14 during the free rolling conditions. In addition, the road condition monitoring system 10 is tire agnostic, and thus provides a robust and accurate system even when different tires 14 are mounted on the vehicle 12.

The present invention also includes a method for estimating a road surface condition 74 over which a vehicle 12 travels. The method includes steps in accordance with the description that is presented above and shown in FIGS. 1 through 8.

It is to be understood that the structure of the above-described road condition estimation system 10 and the steps of the accompanying method may be altered or rearranged, or components or steps known to those skilled in the art omitted or added, without affecting the overall concept or operation of the invention. For example, electronic communication may be through a wired connection or wireless communication without affecting the overall concept or operation of the invention. Such wireless communications may include radio frequency (RF) and Bluetooth® communications. In addition, vehicle and tire characteristics other than those described above and known to those skilled in the art may be employed, without affecting the overall concept or operation of the invention. Moreover, while examples of statistical analysis techniques are provided above, any applicable technique known to those skilled in the art may be employed without affecting the overall concept or operation of the invention.

The invention has been described with reference to a preferred embodiment. Potential modifications and alterations will occur to others upon a reading and understanding of this description. It is to be understood that all such modifications and alterations are included in the scope of the invention as set forth in the appended claims, or the equivalents thereof.

What is claimed is:

1. A road condition monitoring system for a vehicle, the vehicle being supported by at least one tire and including a central communication system, the system comprising:
a processor in electronic communication with the central communication system;
an identifier in electronic communication with the processor, the identifier receiving vehicle condition data from the central communication system and identifying a free rolling instance of the at least one tire;
a slip estimator in electronic communication with the processor, the slip estimator receiving speed data from the central communication system and determining slip characteristics of the at least one tire during the free rolling instance; and
a classifier in electronic communication with the processor, the classifier receiving the slip characteristics of the at least one tire and identifying a road surface condition from the slip characteristics.

2. The road condition monitoring system of claim 1, wherein the slip characteristics include a magnitude of an estimated slip of the at least one tire during the free rolling instance.

3. The road condition monitoring system of claim 1, further comprising a slip adjustor, the slip adjustor estimating a relative change in slip of the at least one tire during the free rolling instance, wherein the slip characteristics include the relative change in slip of the at least one tire.

4. The road condition monitoring system of claim 3, wherein the classifier identifies the road surface condition from a magnitude of the relative change in slip of the at least one tire.

5. The road condition monitoring system of claim 3, wherein the slip adjustor includes a reference slip calculator, the reference slip calculator receiving vehicle atmospheric condition data from the central communication system and estimating a reference slip value of the at least one tire during the free rolling instance.

6. The road condition monitoring system of claim 5, wherein the atmospheric condition data includes an ambient temperature and a relative humidity.

7. The road condition monitoring system of claim 5, further comprising a dry road condition estimator that analyzes the atmospheric condition data to determine if a road on which the vehicle is traveling is dry by generating a probability of road dryness.

8. The road condition monitoring system of claim 5, wherein the reference slip calculator receives a vehicle speed and tire-related data to estimate the reference slip value of the at least one tire during the free rolling instance.

9. The road condition monitoring system of claim 8, wherein the tire-related data includes at least one of a pressure of the at least one tire, a load on the at least one tire, a wear state of the at least one tire, and a position of the at least one tire on the vehicle.

10. The road condition monitoring system of claim 5, wherein the slip adjustor includes a relative slip calculator, the relative slip calculator receiving the reference slip value and a slip estimation from the slip estimator, the relative slip calculator determining the relative change in slip of the at least one tire from the reference slip value and the slip estimation.

11. The road condition monitoring system of claim 1, wherein the classifier employs a multinomial logistic regression classification to identify the road surface condition.

12. The road condition monitoring system of claim 1, where the road surface condition identified by the classifier is according to road surface type, including at least one of a dry surface, a wet surface, a snow-covered surface, and an icy surface.

13. The road condition monitoring system of claim 1, wherein the vehicle condition data received by the identifier includes a vehicle reference speed, a vehicle longitudinal acceleration, a steering wheel angle, a brake pedal command, and a gas pedal position.

14. The road condition monitoring system of claim 13, wherein the identifier includes a threshold based event classifier, including at least one of a linear classifier, a nonlinear classifier, and a Bayesian statistical classifier.

15. The road condition monitoring system of claim 14, wherein the vehicle condition data are categorized by each respective vehicle condition, with predetermined thresholds are set for each vehicle condition, and when the predetermined thresholds are met, a free rolling instance of the at least one tire is identified.

16. The road condition monitoring system of claim 1, wherein the speed data received by the slip estimator includes a vehicle reference speed and a wheel speed.

17. The road condition monitoring system of claim 16, wherein the slip estimator estimates a slip of the at least one tire as a percentage difference between the vehicle reference speed and the wheel speed.

18. The road condition monitoring system of claim 17, wherein the slip estimator employs a recursive least squares algorithm with a forgetting factor.

19. The road condition monitoring system of claim 1, wherein the road surface condition identified by the classifier is output from the road condition monitoring system to at least one of a vehicle control system and a discrete estimation system.

20. The road condition monitoring system of claim 19, wherein the discrete estimation system includes a tire grip estimation system.
